(19) United States
(12) Patent Application Publication
(10) Pub. No.: US 2008/0166689 A1
(43) Pub. Date: Jul. 10, 2008

(54) Words

(76) Inventor: Timothy Gerard Joiner, Livermore, CA (US)

Correspondence Address: TIMOTHY G. JOINER, 336 Yosemite Dr., LIVERMORE, CA, 94551, US

(21) Appl. No.: 11/620,331

(22) Filed: Jan. 5, 2007

(51) Int. Cl. G09B 17/00

(52) U.S. Cl. 434/167

(57) ABSTRACT

In Words is an enunciation game recognizing the pronunciation of letters as alphabet letters and the enunciation of additional words during the enunciation of any one word.

### CROSS-REFERENCE TO RELATED APPLICATIONS

None

### STATEMENT REGARDING FEDERALLY SPONSORED RESEARCH OR DEVELOPMENT

None

### REFERENCE TO SEQUENCE LISTING, A TABLE, OR A COMPUTER PROGRAM LISTING COMPACT APPENDIX

None

### BACKGROUND OF THE INVENTION

This invention falls into the field of educational games.

### BRIEF SUMMARY OF THE INVENTION

In Words is an enunciation game that identifies the pronunciation of letters as alphabet letters in the enunciation of any one word. Also, In Words identifies the enunciation of additional words during the enunciation of any one word. Finally, In Words identifies the pronunciation of letters as alphabet letters and the enunciation of additional words during the enunciation of the same one word.

### BRIEF DESCRIPTION OF THE SEVERAL VIEWS OF THE DRAWING

None

### DETAILED DESCRIPTION OF THE INVENTION

I The enunciation of any word in the English language that pronounces a letter or letter's from the alphabet as an alphabet letter earns 5 points per letter pronounced as an alphabet letter.

### EXAMPLES

1) The word MAKE pronounces the letter A as an alphabet letter and the letter A is worth 5 points.
2) The word SHOW pronounces the letter O as an alphabet letter and the letter O is worth 5 points.
3) The word EAT pronounces the letter E as an alphabet letter and the letter E is worth 5 points.
4) The word MARIE pronounces the letter E as an alphabet letter. The letter E earns 5 points.
5) The word CELEBRATE pronounces the letter L and A as alphabet letters and the letter L and A are worth 5 points each for a total of 10 points.
6) The word MICROWAVE pronounces the letter I, O, and A as alphabet letters and the letters I, O, and A are worth 5 points each for a total of 15 points.
7) The word GAINSAY pronounces the letter A as an alphabet letter two times each time worth 5 points for a total of 10 points. This word is worth an additional 5 points because of the pronunciation of the same letter multiple times. The word GAINSAY is worth a total of 15 points.
8) The word SELENIUM pronounces the letter E as an alphabet letter two times. Each time is worth 5 points for a total of 10 points. This word is worth an additional 5 points because of the pronunciation of the same letter multiple times and this word is worth an additional 5 points because the second pronunciation of the letter E as an alphabet letter does not use the letter E in the spelling of the word.
9) The word BELL pronounces the letter L as an alphabet letter Although there are two L's in the spelling of the word BELL, the letter L is pronounced only once. Therefore, the word BELL is worth 5 points.
10) The word MAYBE pronounces the letters A and B as alphabet letters. This word is worth 10 points because two different letters from the alphabet are pronounced as alphabet letters, each letter being worth 5 points. Also this word MAYBE earns an additional 5 points because the letters A and B are pronounced in alphabetical order. The word MAYBE is worth a total of 15 points.
11) The word BEEHIVE pronounces the letters B and I as alphabet letters. This word is worth 10 points because two different letters from the alphabet are pronounced as alphabet letters, each letter being worth 5 points. Also, the word BEEHIVE earns an additional 5 points because the letters B and I are pronounced in alphabetical order. The word BEEHIVE is worth a total of 15 points.
12) The word SEA pronounces the letter C as an alphabet letter. The word SEA is worth 5 points for the pronunciation of the letter C. The word SEA is worth an additional 5 points because the letter C is not used in it's spelling. The total amount of points for the word SEA is 10 points.

III The enunciation of any word in the English language that enunciates other words during its enunciation earns 5 points per additional word enunciated.

### EXAMPLES

1) The word BASH enunciates the word ASH. The word ASH earns 5 points.
2) The word FAN enunciates the word AN. The word AN earns 5 points.
3) The word FARE enunciates the word AIR. The word AIR earns 5 points.
4) The word I enunciates the word EYE. The word EYE earns 5 points.
5) The word HAZMAT enunciates the word AS, the word MAT, and the word AT. AS earns 5 points, MAT earns 5 points, and AT earns 5 points. The word HAZMAT is worth a total of 15 points..

III. The enunciation of any word in the English Language that pronounces a letter or letters from the alphabet as an alphabet letter and enunciates other words during the enunciation earns 5 points per letter pronounced as an alphabet letter and 5 points per additional word enunciated.
All the rules applied in I, II, are combined to form III.

### EXAMPLES

1) The word GYMNASIUM pronounces the letter A and the Z as alphabet letters. The letter A earns 5 points and the letter Z earns 5 points. The letters A and Z in the word GYMNASIUM are pronounced in alphabetical order and this earns an additional 5 points because of the use of alphabetical order. The pronunciation of the letter Z is worth an additional 5 points because the letter Z is not used in the spelling of the word GYMNASIUM. The word GYMNASIUM enunciates the word JIM. The word JIM earns 5 points. The word GYMNASIUM earns a total of 25 points.
2) The word ROYALTY pronounces the letter T as an alphabet letter. The letter T earns 5 points. The word ROYALTY enunciates the word ROY. The word ROY earns 5 points.
The word ROYALTY earns a total of 10 points.

What I claim as my invention is:

1. The enunciation of any word in the English language that pronounces a letter or letter's from the alphabet as pronounced as an alphabet letter earns 5 points per letter pronounced as an alphabet letter.

2. As per claim 1 if an alphabet letter pronounced as an alphabet letter is pronounced multiple times and is the same letter it earns 5 points per pronunciation as an alphabet letter with an additional 5 points earned because it has been used multiple times.

3. As per claim 1 if multiple letters are pronounced as an alphabet letter and all the letters pronounced as alphabet letters are pronounced in alphabetical order then each letter pronounced as an alphabetical letter is worth 5 points and an additional 5 points is earned because of the use of alphabetical order.

4. As per claim 1 if the alphabet letter or letters pronounced as an alphabet letter are not in the spelling of the enunciated word from the English language then each letter pronounced as an alphabet letter is worth 5 points and an additional 5 points is earned per letter pronounced as an alphabet letter without its spelling in the enunciated English language word.

5. The enunciation of any word in the English language that enunciates other words during its enunciation earns 5 points per additional word enunciated.

6. As per claim 5 one letter spelling words also earns 5 points per word.

7. As per claim 1, 2, 3, 4, 5, and 6 the enunciation of any word in the English Language that pronounces a letter or letters from the alphabet as an alphabet letter and enunciates other words during the enunciation earns points.
